(19) United States
(12) Patent Application Publication
(10) Pub. No.: US 2004/0024861 A1
(43) Pub. Date: Feb. 5, 2004

(54) Network load balancing

(76) Inventor: Chesley B. Coughlin, San Diego, CA (US)

Correspondence Address: BUCKLEY, MASCHOFF, TALWALKAR LLC, 5 ELM STREET, NEW CANAAN, CT, 06840, US

(21) Appl. No.: 10/185,329

(22) Filed: Jun. 28, 2002

(51) Int. Cl. G06F 15/173

(52) U.S. Cl. 709/224; 709/225

(57) ABSTRACT

A method, apparatus, and system for balancing load between network nodes.

### BACKGROUND OF THE INVENTION

In computer networks, including for example the World Wide Web, interactions occur between user processors or “clients” that desire to conduct transactions and provider processors or “servers” through which the clients interact. Typically, a provider will configure a plurality of servers to interact with a large number of clients to meet expected peak demands from clients. Thus, there may be a need for a system, apparatus, and method by which the load incident on each server is balanced, taking into consideration the operational load on each server so that overall system performance may be maximized.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features, and advantages thereof, may best be understood by reference to the following detailed description wherein like reference numerals are employed to designate like parts or steps, when read with the accompanying drawings in which:

FIG. 1 is a block diagram of a system suitable for practicing an embodiment of the invention;

FIG. 2 is a block diagram of a load balancer suitable for practicing an embodiment of the invention;

FIG. 3 is a flowchart depicting an embodiment of a method of performing load balancing;

FIG. 4 is a flowchart depicting an embodiment of a method of selecting a server to be load balanced; and

FIG. 5 is a flowchart depicting an embodiment of a method of determining whether to additionally load a server.

### DETAILED DESCRIPTION OF THE INVENTION

Reference will now be made in detail to the preferred embodiments of the present invention, examples of which are illustrated in the accompanying drawings. It is to be understood that the Figures and descriptions of embodiments of the present invention included herein illustrate and describe elements that are of particular relevance, while eliminating, for purposes of clarity, other elements found in typical computers and computer networks.

The present network load balancer provides solutions to the shortcomings of load balancing performed on networks. Those of ordinary skill in the art will readily appreciate that the invention, while described in connection with World Wide Web applications, is equally applicable to any network including, for example, the Internet or a wide area network. Other details, features, and advantages of the network load balancer will become further apparent in the following detailed description of the embodiments.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment.

In the present embodiment, the term “server” refers to a network node that may include a processor or a computer coupled to the World Wide Web or another network and that communicates with other processors on that network via, for example, a Hypertext Transfer Protocol (HTTP) application (e.g., Apache™ HTTP Server) or an application server (e.g., SendMail™). A server furthermore recognizes a request from a client. A “client” is a network node that may include a processor having a browser (e.g., Microsoft® Internet Explorer™ or Netscape®) or another client application (e.g., Microsoft® Outlook®) that communicates with a server. A client transmits one or more requests to a server. The term “load balancer” refers to a network node that may include a processor or a computer coupled to the network and that communicates with other processors on the network including clients and servers. A load balancer may be a separate node or may be incorporated into another node such as, for example, a server. A node refers to any device coupled to the network including clients, caches, proxies, and servers. A “data center” refers to a group of at least two servers and may include a load balancer.

Also in the present embodiment, a “session” consists of one or more communications via, for example, serial communication between a client and a server over one or more connections. A connection contains one or more requests with a corresponding response between a client and a server.

The Internet is a network of computers, dumb terminals, or other, typically processor-based, devices interconnected by one or more forms of communication media. The World Wide Web is a subset of the Internet. Typical interconnected devices range from handheld computers and notebook PCs to high-end mainframe and supercomputers. Clients and servers are examples of types of devices that are interconnected to the Internet. The communication media coupling those devices include twisted pair, co-axial cable, optical fibers and wireless communication methods such as use of radio frequencies.

Network nodes may be equipped with hardware, software and/or firmware necessary to communicate information over the network in accordance with one or more protocols. A protocol may comprise a set of instructions by which the information signals are communicated over a communications medium. Protocols are, furthermore, often layered over one another to form something called a “protocol stack.” In one embodiment of the invention, the network nodes operate in accordance with a packet switching protocol referred to as the Transmission Control Protocol (TCP) as defined by the Internet Engineering Task Force (IETF) standard 7, Request For Comment (RFC) 793, adopted in September, 1981 (“TCP Specification”), and the Internet Protocol (IP) as defined by the IETF standard 5, RFC 791 (“IP Specification”), adopted in September, 1981, both available from “www.ieff.org” (collectively referred to as the “TCP/IP Specification”).

An end user device connected to the Internet or the World Wide Web, such as a client, typically includes a program, such as a browser, that communicates between applications operating on the client and the TCP/IP protocol stack. TCP packages data into packets that typically include the address of the node from which the packet originates, the size of the packet where applicable, and the address of the destination node to which the packet is to be delivered, such as a server. Because data is usually sent in multiple packets, the packets also typically include a label indicating the order in which they are to be assembled once they arrive at their destination. After the packets are created, the IP layer transmits the packets across a network such as the Internet.

World Wide Web communication involves another protocol referred to as the Hypertext Transfer Protocol (HTTP) that permits the transfer of Hypertext Markup Language (HTML) documents between computers. HTTP is defined by the Internet Engineering Task Force (IETF) standard 1.1, Request for Comment (RFC) 2068, adopted January, 1997. HTML is defined by the IETF standard 4.0, RFC 3236, adopted January, 2002. Both the HTTP specification and the HTML specification are available from “www.ieff.org.”

Communication in protocols other than HTTP may also benefit from use of embodiments of the present invention. For example Simple Object Access Protocol (SOAP) formatted data may include information that aids in balancing the load applied to servers. SOAP is a minimal set of conventions for exchange of information in a decentralized, distributed environment. It is an XML based protocol that is currently implemented on HTTP and consists of four parts: an envelope that defines a framework for describing what is in a message and how to process it, a transport binding framework for exchanging messages using an underlying protocol, a set of encoding rules for expressing instances of application-defined data types, and a convention for representing remote procedure calls and responses. SOAP is defined by the W3C standard 1.1, which was submitted May 8, 2000 and is available from “www.w3.org.”

The HTML documents are often referred to as “web pages” and are files containing information in the form of text, videos, images, links to other web pages, and so forth. Each web page is stored in a node that is typically a processor based device that is interconnected to the World Wide Web and may be a type of server. Each node has a unique address referred to as a Universal Resource Locator (URL). The URL is used by a program referred to as a “web browser” located on one interconnected computer to find a web page stored somewhere on another computer connected to the network. That creates a “web” of computers each storing a number of web pages that can be accessed and transferred using a standard protocol, and hence this web of computers is referred to as the World Wide Web.

Nodes may operate as source nodes, destination nodes, intermediate nodes or a combination of those source nodes, destination nodes, and intermediate nodes. Information is passed from source nodes to destination nodes, often through one or more intermediate nodes. Information may comprise any data capable of being represented as a signal, such as an electrical signal, optical signal, acoustical signal and so forth. Examples of information in this context may include data from a voice conversation, videoconference, streaming video, electronic mail (“email”) message, voice mail message, graphics, image, video, text and so forth.

Current data centers utilize multiple servers, typically containing identical content, for scalability and redundancy. Scalability permits the data centers to provide data to all clients at current peak loads and to permit the amassing of additional servers to meet increasing future demands. Redundancy permits the data centers to accommodate and/or transfer system load upon failure of one or more servers. Load balancing aims to spread tasks among those multiple servers to avoid a situation in which one or more servers are idle while one or more other servers are occupied to the extent that tasks are queuing for execution. Thus, a load balancer routes client requests or connections to a particular server based on the availability of the servers.

When tasks queue for execution, those tasks are waiting for processing time and, therefore, are not being executed immediately. Thus, if the queued task were to be processed through a server having idle time, the task could be processed without the waiting time added by the queue, thereby increasing the efficiency of handling of that data request. It is therefore a goal to have all servers in the data center to be equally utilized based on server metrics.

Server metrics, as that term is utilized herein, include, for example, server central processing unit utilization, server memory utilization, and the number of open connections available at the server. Server metrics are also referred to as “server characteristics.”

Load balancing may be performed by a variety of nodes. Load balancing may be performed by heavily loaded nodes, for example having queued tasks, that send tasks to other processors. Load balancing may alternately or in addition be performed by lightly loaded nodes, for example idle nodes, that request tasks from other processors. Load balancing may alternately or in addition be performed by a centralized task distribution mechanism that distributes connections and sessions to various servers in the data center.

Techniques utilized to balance load among servers include Round Robin and Least Number of Connections. The Round Robin method loops through a list of servers assigning each new client connection to a new server in rotation. The Round Robin method may, for example, include a counter that increments to the number of servers existing in the data center. Servers may be assigned unique numbers, such as IP addresses, that are associated with each increment. Each time a new client makes a request of the data center the counter is incremented and the load balancer assigns the new request to the server associated with the current counter value. Often, all additional requests made by that client in the session are also handled by the server assigned at the time the new request was received. When the counter value increments from the value associated with the highest numbered server, the counter returns to the lowest numbered server. Thus, each server is assigned the same number of new transactions. The Round Robin method, however, does not take into account the complexity of the client requests or the number of request made in each session.

The Round Robin method also does not take into account the various capacities of the servers. For example, a certain server processor may be faster than a processor in another server and, thus, able to handle more sessions. A third server may have more memory than a fourth server and, thus, be able to handle more sessions than the fourth server. The Round Robin method is disadvantageous because it does not consider the complexity of sessions and the available capacity of servers in the data center.

The Least Number of Connections method assigns a new request to the server currently utilizing the fewest connections. Like Round Robin, the session following an assignment in the Least Number of Connections method typically is also handled by the server assigned at the time the new request was received. Thus, if a certain server is serving four clients and another server is serving three clients, then the server serving three clients would be selected to serve the next client over the server serving four clients. Alternately, the Least Number of Connections method may assign a new request to the server having the greatest number of unused connections. The Least Number of Connections method, however, also does not take into account the complexity of the client requests or the number of request made in each session.

Furthermore, the Least Number of Connections method does not take into account the various capacities of the servers. For example, a certain server may have more connections than another server, or greater memory capacity or greater processor speed and, thus, be capable of handling more sessions. The Least Number of Connections method is therefore also disadvantageous because it does not consider the complexity of sessions and the available capacity of servers in the data center.

The present load balancer considers the load placed on each server to improve load balancing. The present load balancer may furthermore consider that load in comparison to the capacity of each server. Thus, the load balancer may calculate the current load placed on each server and/or may calculate the current load placed on each server as a part or percentage of the total load that server is capable of processing. Various server loads may then be compared either to each other or to a set of thresholds to determine which server or servers are most able to handle future client request.

It should be noted that the load balancer may assign a task to a server and assign that server to transact with that client throughout the entire client session. Alternately, the load balancer may assign a different server to transact with a client at mid-session when the server originally transacting with the client becomes heavily loaded.

A method of monitoring a characteristic of a server on a network is included in an embodiment of the load balancer. In that embodiment, data describing a current operating level of a characteristic as it relates to a first server is included in a message sent from the first server. The current operating level of the characteristic for the first server is then read from the message sent from the first server by a load balancer.

In that method, each server in the data center may include one or more operating characteristics in messages sent from those servers to clients in response to requests made by those clients. The operating characteristics may furthermore be included in one or more headers of the message. Those headers may be standard headers included in a communication protocol such as, for example, HTTP and/or SOAP protocols. The message may be transmitted to the client through the load balancer or transmitted to the load balancer and the client in parallel. Where the message is transmitted to the client serially through the load balancer, the characteristics may be read from the header and then the message may be forwarded to the client. Where the message is transmitted to both the load balancer and the client in parallel, the operating characteristics may simply be read from the header by the load balancer and then the message may be discarded by the load balancer. It should be noted that the load balancer may be a module executed by a processor in common with the server. Thus, the term “transmitting” includes transmissions across a network as well as transmissions from one module to another module within a single processor.

Whether the message is transmitted serially or in parallel, the body of the message is unaltered by the inclusion of the characteristic in the header. Thus, the message read by the client is the appropriate response. Once the characteristic has been received from the servers in the data center, the load balancer is able to compare the characteristic to thresholds or other servers to balance server load. The load balancer may then assign incoming requests from clients to the server or servers that are least loaded.

It should be noted that where one or more server is not operating, the load balancer may balance the load between the operating servers.

A method of distributing data communication load between at least two servers is included in an embodiment of the load balancer. In that embodiment, data describing a current operating level of a characteristic as it relates to a first server is included in a message sent from the first server. The current operating level of the characteristic for the first server is then read from the message sent from the first server at a load balancer. Data describing a current operating level of a characteristic as it relates to a second server is included in a message sent from the second server. The current operating level of the characteristic for the second server is then read from the message sent from the second server at the load balancer. A request from a client is then transmitted to the first server if the operating level of the characteristic is better for the first server than the operating level of the characteristic is for the second server and the request from the client is transmitted to the second server if the operating level of the characteristic is better for the second server than the operating level of the characteristic is for the first server.

The characteristic may be any characteristic related to server loading. For example, server metrics including processor utilization, memory utilization, and the number of open connections interconnected to the server are appropriate characteristics to be considered. Each characteristic may, furthermore, be expressed as a portion of the total amount of that characteristic available to that server. Thus, for example, memory utilization may be expressed as an amount of memory utilized by a server or as a portion of the total memory available to that server. More than one characteristic may, furthermore, be considered by the load balancer.

The message in which the operating level of the characteristic is transmitted may be a message sent from the server in question to one or more clients. Moreover, the operating level of the characteristic may be added to or included in a header such as, for example, an HTTP protocol header. Thus, the characteristic operating level may be transmitted to the load balancer with no requirement for custom formatting with minimal additional overhead; and without creating any additional network traffic.

In an embodiment, an example HTTP header received at a load balancer from a server might include the following data: ps

HTTP/1.1 200 OK

Date: Wednesday, Jun. 12, 2002 20:23:52 GMT

TransparentServerAgentData: CPU 50, MEM 25, CON 200

Content-type: image/gif

Content-length:2859

Data related to the load balancer is included in the line beginning “TransparentServerAgentData.” The “CPU 50” field may indicate that the central processing unit of the server sending that message is currently operating at 50% of its maximum usage. The “MEM 25” field may indicate that 25% of the memory of the sending server is currently utilized. The “CON 200” field may indicate that the sending server has 200 open connections.

In an embodiment, the load balancer may be implemented in a server. The server includes a processor containing instructions which, when executed by the processor, cause the processor to write an operating level of a characteristic of the server in a message responding to a request from a client, the message being received by a load balancer and the client.

In another embodiment, the load balancer may be implemented in a load balancing device. The load balancing device includes a processor containing instructions. When the processor executed the instructions the processor reads an operating level of a characteristic of a first server corresponding to the portion of the first server being utilized and reads an operating level of a characteristic of a second server corresponding to the portion of the second server being utilized. The processor then transmits a request from a client to the first server if the portion of the first server being utilized is less than the portion of the second server being utilized and transmits the request from the client to the second server if the portion of the second server being utilized is less than the portion of the first server being utilized.

In an embodiment, the load balancer may be implemented in a load balancing system. The load balancing system includes first, second and third clients, first and second servers, and a load balancer, all coupled to a common network. The first client communicates a request over the network. The first server communicates a current operating level of a characteristic of the first server that corresponds to the load of the first server in a message transmitted to the second client. The second server communicates a current operating level of the characteristic of the second server that corresponds to the load of the second server in a message transmitted to the third client. The load balancer has a processor, that contains instructions which, when executed by the processor, cause the processor to receive the request from the first client, receive the message transmitted from the first server to the second client, and receive the message transmitted from the second server to the third client. The load balancer reads the current operating level of a characteristic of the first server from the message transmitted from the first server to the second client and reads the current operating level of a characteristic of the second server from the message transmitted from the second server to the third client. The load balancer then transmits the request from the first client to the first server if the load of the first server is less than the load of the second server and transmits the request from the first client to the second server if the load of the second server is less than the load of the first server.

An embodiment of the load balancer includes a computer readable medium having stored thereon instructions to be executed by a processor. When the instructions are executed by the processor, the processor reads an operating level of a characteristic of a first server, the operating level of the characteristic of the first server corresponding to the portion of the first server being utilized and reads an operating level of a characteristic of a second server, the operating level of the characteristic of the second server corresponding to the portion of the second server being utilized. The processor then transmits a request from a client to the first server if the portion of the first server being utilized is less than the portion of the second server being utilized and transmits the request from the client to the second server if the portion of the second server being utilized is less than the portion of the first server being utilized.

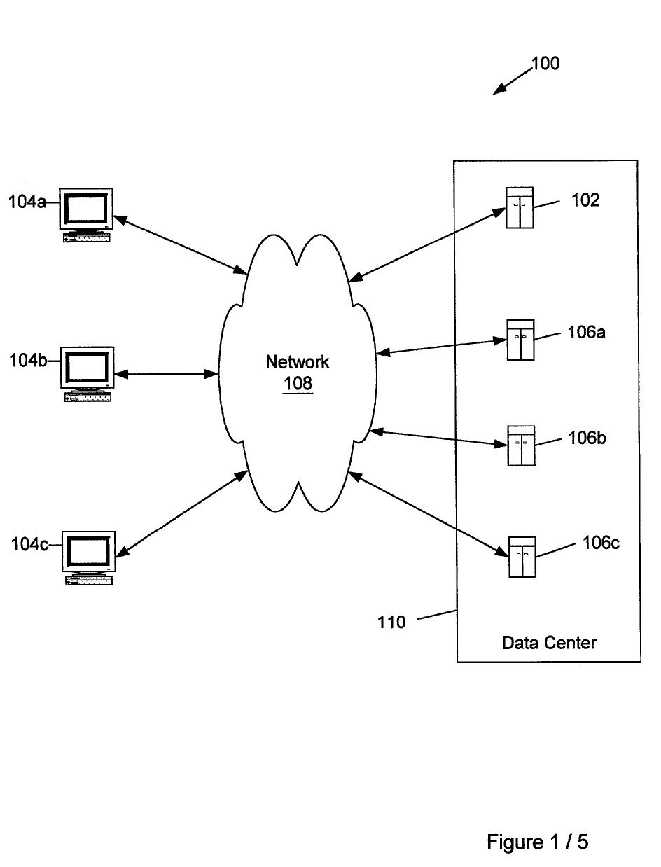

FIG. 1 illustrates an embodiment of a load balancer system 100 that automatically balances load placed on servers 106a, 106b, and 106c. Servers are referred to collectively hereinafter as “106.” That load may be data processing load placed by client 104a, 144b, and 104c requests for data stored on those servers 106. Clients are referred to collectively hereinafter as “104.” In that embodiment, nodes 102, 104, and 106 are coupled to a network 108. Each node 102, 104, and 106 includes a protocol that performs a desired operation. Those protocols may, furthermore, be in the form of instructions that are executed by a processor at each node 102, 104, and 106.

The embodiment illustrated in FIG. 1 includes a plurality of clients 104a, 104b and 104c communicating with a plurality of servers 106a, 106b and 106c over a network 108. A load balancer 102 is also communicating with one or more of the plurality of clients 104a, 104b and 104c and one or more of the servers 106a, 106b and 106c over the network 108. In that embodiment, the servers 106 and the load balancer 102 comprise the data center 110, which provides requested data to clients such as those referred to as 104a, 104b, and 104c.

Servers 106 in the data center 110 may be placed in close proximity, or placed at various locations. Thus, for example, server 106a may be physically located in Los Angeles, while server 106b is located in San Francisco and server 106c is located in Seattle. The load balancer 102 may be located at any of those locations or yet another location.

Although the load balancer system 100 illustrates only three clients 104a, 104b and 104c, three servers 106a, 106b and 106c, and one load balancer 102 for conciseness, it should be appreciated that any number of clients 104, servers 106, and load balancers 102 may be implemented as part of the load balancer system 100 and still fall within the scope of embodiments of the present invention.

It should also be recognized that the load balancer 102 may be located serially between the clients 104 and the servers 106 so that all messages pass through the load balancer 102. It is not necessary, however, for the load balancer 102 to be placed between the clients 104 and the servers 106.

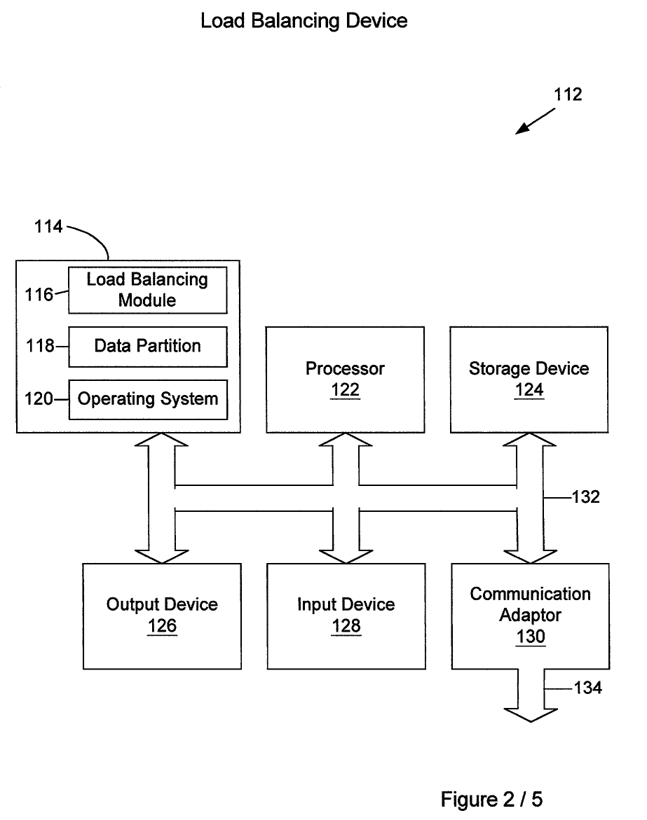

FIG. 2 illustrates a load balancing device 112 that performs the load balancing function in one embodiment in which the session integrity proxy operates in a device separate from the client 104 and server 106. The load balancing device 112 includes memory 114, a processor 122, a storage device 124, an output device 126, an input device 128, and a communication adaptor 130. Communication between the processor 122, the storage device 124, the output device 126, the input device 128, and the communication adaptor 130 is accomplished by way of one or more communication buses 132.

The memory 114 may, for example, include random access memory (RAM), dynamic RAM, and/or read only memory (ROM) (e.g., programmable ROM, erasable programmable ROM, or electronically erasable programmable ROM) and may store computer program instructions and information. The memory may furthermore be partitioned into sections in which operating system 120 instructions are stored, a data partition 118 in which data is stored, and a load balancing module 116 partition in which instructions for carrying out load balancing functionality are stored. The load balancing module 116 partition may store program instructions and allow execution by the processor 122 of the program instructions to implement the functions of each respective node described herein, such as the clients 104a, 104b, and 104c and the servers 106a, 106b, and 106c. The data partition 118 may furthermore store data to be used during the execution of the program instructions.

The processor 122 may, for example, be an Intel® Pentium® type processor or another processor manufactured by, for example Motorola®, Compaq®, AMD®, or Sun Microsystems®. The processor 122 may furthermore execute the program instructions and process the data stored in the memory 114. In one embodiment, the instructions are stored in memory 114 in a compressed and/or encrypted format. As used herein the phrase, “executed by a processor” is intended to encompass instructions stored in a compressed and/or encrypted format, as well as instructions that may be compiled or installed by an installer before being executed by the processor.

The storage device 124 may, for example, be a magnetic disk (e.g., floppy disk and hard drive), optical disk (e.g., CD-ROM) or any other device or signal that can store digital information. The communication adaptor 130 permits communication between the load balancing device 112 and other devices or nodes coupled to the communication adaptor 130 at the communication adaptor port 134. The communication adaptor 130 may be a network interface that transfers information from nodes on a network to the load balancing device 112 or from the load balancing device 112 to nodes on the network. The network may be a local or wide area network, such as, for example, the Internet, the World Wide Web, or the load balancing system 100 illustrated in FIG. 1. It will be recognized that the load balancing device 112 may alternately or in addition be coupled directly to one or more other devices through one or more input/output adaptors (not shown).

The load balancing device 112 may also be coupled to an output device 126 such as, for example, a monitor or printer, and an input device 128 such as, for example, a keyboard or mouse. It will be recognized, however, that the load balancing device 112 does not necessarily need to have an input device 128 or an output device 126 to operate. Moreover, the storage device 124 may also not be necessary for operation of the load balancing device 112.

The elements 114, 122, 124, 126, 128, and 130 of the load balancing device 112 may communicate by way of one or more communication busses 132. Those busses 132 may include, for example, a system bus, a peripheral component interface bus, and an industry standard architecture bus.

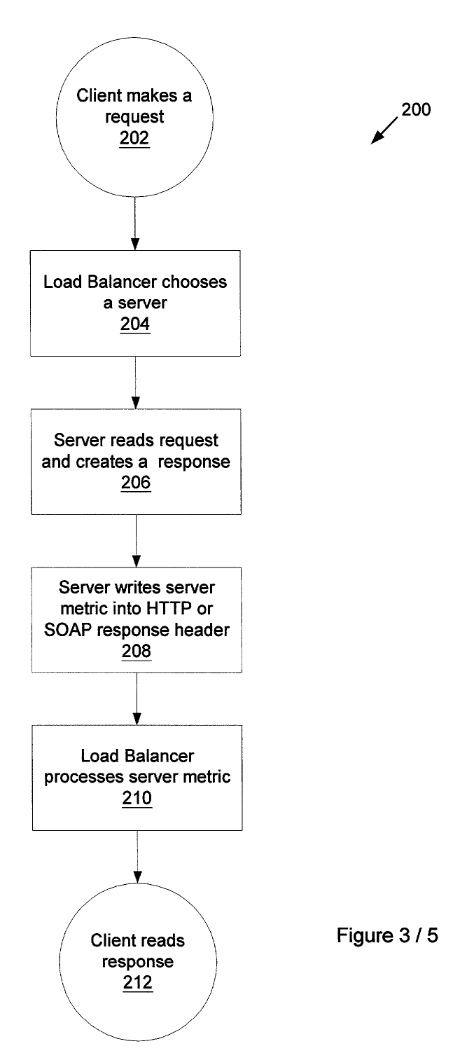

FIG. 3 illustrates data flow 200 in a certain embodiment of the load balancer wherein the load balancer 102 is not placed operationally between the clients 104 and servers 106. At 202, a request for data from the data center 110 is transmitted by the client 104a and is received at the load balancer 102. At 204, the load balancer 102 selects one of the servers 106a, 106b, or 106c in the data center 110 to service the client 104a request. The load balancer 102 then routes the request to the selected server 106a thereby beginning a session that typically would include multiple requests from the client 104a and multiple responses from the selected server 106a. In this example, the client 104a has requested information and has been directed by the load balancer 102 to participate in a session with server 106a. Server 106a transmits a response to client 104a. At 206, server 106a prepares a response to the request and at 208, server 106a includes server metrics or characteristics in a header of the response. The server metrics or characteristics included in the header in this example include (i) current CPU usage for that server as a percentage of the CPU capacity of that server, (ii) current memory utilized by that server as a percentage of the total memory contained in that server, and (iii) the number of connections currently available at that server.

The response message, with server characteristics included in the header, is then transmitted to the client 104a. The same response message is also transmitted to the load balancer 102. At the load balancer 102, the server characteristics are read from the header of the response message. The load balancer 102 also receives characteristic data from all other servers 106b, and 106c in the data center 110. At 210, the load balancer 102 places the characteristics into an algorithm to arrive at a load for each server 106. The load balancer 102 will utilize that load to assign the next new client request to a server 106 having capacity to be further loaded. At 212, the client reads the response and may make one or more additional requests.

In an embodiment wherein central processing unit (CPU) utilization is determinative of load, CPU usage may be included in messages sent from each server 106. The server 106 having the lowest CPU usage is identified by the load balancer 102 as the server 106 having the least load. The server 106 having the next lowest CPU usage is identified by the load balancer 102 as the server 106 having the second least load and so on such that each server 106 is ranked by CPU usage. Those servers 106 having the least CPU usage are then assigned new client requests.

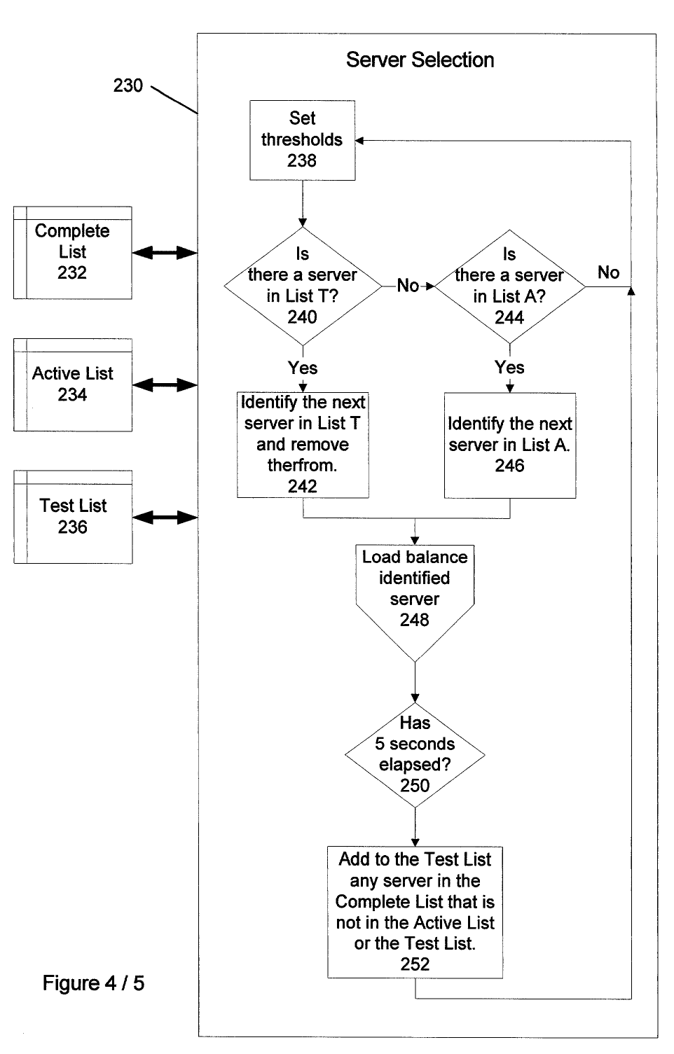

FIG. 4 illustrates a server selection process 230 in a load balancing embodiment wherein CPU usage, memory usage, and connection usage are considered in determining server load. In that embodiment, usage characteristics of each server are compared to one or more threshold levels to determine whether each server 106 is capable of accepting additional new client requests. Server usage is, thus, not compared to other server usage, but rather to the thresholds. That embodiment includes three lists: (1) a Complete List 232, which includes all servers 106 in the data center 110, (ii) an Active List 234, which includes all active servers 106 in the data center 110, and (iii) a Test List 236, which includes all servers 106 in the data center that are to be tested by the load balancer 102. At 238, thresholds are set for the characteristics to be considered: (i) CPU utilization as a portion of total CPU capacity, (ii) memory utilization as a portion of total memory capacity, and (iii) the number of open connections available. The threshold for CPU usage may be, for example, 50% of CPU capacity, the threshold for memory usage may be, for example, 90% of memory capacity, and the threshold for number of open connections may be, for example, 100 connections. At 240, a determination is made as to whether a server 106 exists in the Test List 232. If a server does exist in the Test List, then a server 106 in the Test List is identified to be load balanced and removed from the Test List at 242. If no server 106 is included in the Test List, then a determination is made as to whether a server 106 exists in the Active List 234. If a server 106 exists in the active list, then a server 106 is selected from the Active List 234 in round robin fashion at 244. If there are no active servers 106 in the Test List 232 or the Active List 234 then no load balancing will occur.

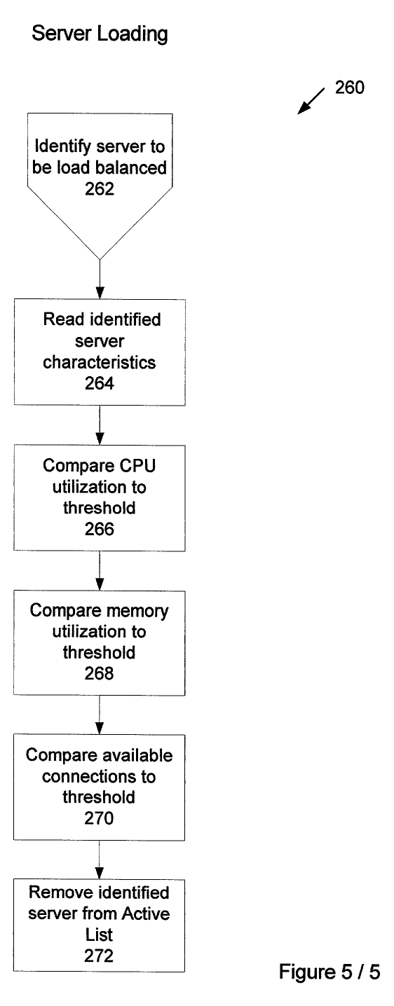

At 248, load balancing is performed on a server 106 selected from the Test List 232 or, if no server exists in the Test List, a server 106 selected from the Active List 234. An embodiment of such load balancing of a selected server 106 is illustrated in FIG. 5.

At 250 and 252, servers 106 coming on-line are added to the Test List. At 250, servers 106 are considered for addition to the Test List every five seconds. Any server 106 that is in the Complete List that is not in either the Active List or Test List is added to the Test List at 252. In that way, any server 106 coming on-line will be considered for assignment of a request from a new client 104 within 5 seconds of the time it comes on-line.

FIG. 5 illustrates a decision process 260 for determining whether to send a new session to the server 106 selected in the server selection process 230 of FIG. 4. At 262, the server 106 identified in the server selection process 230 of FIG. 3 is selected for load balancing. In this example, the identified server will be server 106b. Server characteristics for the server 106b are determined at 264. Those characteristics include CPU usage as a portion of total CPU capacity, memory usage as a portion of total memory capacity, and the number of open connections available. Those characteristics are read from the header of a response sent from the server 106b to a client 104 in a response to that client 104 in a current session. At 266, the CPU usage of the server 106b is compared to the threshold. If the server 106b is utilizing more of its CPU than the CPU threshold level, in this example 50%, then that server 106b is not added to the Active List. If CPU usage is less than the CPU threshold, then memory usage is compared to the threshold at 268. If the server 106b is utilizing more of its memory than the memory threshold level, in this example 90%, then that server 106b is not added to the Active List. If memory usage is less than the memory threshold, then the number of open connections is compared to the connection threshold at 270. If the number of open connections is less than the connection threshold, in this example 100, then the server 106b is not added to the Active List. If all three thresholds are met, however, then the identified server 106b is added to the Active List. It should be recognized that the thresholds may be applied in any order to obtain the same result.

Server loading may be calculated continuously as messages are received or may be calculated periodically. In the example illustrated in FIG. 4, server characteristics server loading was considered every five seconds utilizing the most recent characteristic data received from each server 106. Thus, the least loaded server 106 would be determined only once every five seconds. Such scheduled comparison would minimize the resources required at the load balancer and would be appropriate where loading is unlikely to change drastically in five seconds.

It may also be beneficial to place server characteristics at the beginning of the header to speed reading of the characteristics at the load balancer 102.

The load balancer thus provides improved load balancing. Moreover, that improved load balancing is accomplished without requiring additional messages to be sent over the network. Inclusion of server characteristic data in the header of messages also does not cause incompatibility issues with non-load balancer enabled systems. Those non-load balancer enabled systems may rather simply ignore the server characteristic data included in the message headers. The load balancer is also easy to deploy because it utilizes existing header space to carry server characteristic data.

While the load balancer has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method of monitoring a characteristic of a server on a network, comprising:
including an operating level of a characteristic as it relates to a first server in a message sent from the first server, and
reading the operating level of the characteristic for the first server from the message sent from the first server by a load balancing agent.

2. The method of claim 1, wherein the data describing the operating level of the characteristic as it relates to the first server is included in a header of a communication protocol utilized to transmit the message from the server to the load balancer.

3. The method of claim 1, wherein the message is a response to a request received at the server from a client.

4. The method of clam 3, wherein the message is transmitted from the server to the load balancer and from the load balancer agent to the client.

5. The method of claim 3, wherein the message is transmitted from the server to the load balancer and the client in parallel.

6. The method of claim 1, wherein the data describing the operating level of the characteristic as it relates to the first server is compared by the load balancer to an operating level of the characteristic as it relates to a second server.

7. The method of claim 6, wherein the operating level of the characteristic as it relates to the first server is indicative of a current load of the first server, the operating level of the characteristic as it relates to the second server is indicative of a current load of the second server, and a client request is routed to the server that is least loaded.

8. The method of claim 1, wherein the server includes a processor and the characteristic is processor utilization.

9. The method of claim 1, wherein the server includes a processor and the characteristic is processor utilization as a portion of processor capacity.

10. The method of claim 1, wherein the server includes memory and the characteristic is memory utilization.

11. The method of claim 1, wherein the server includes memory and the characteristic is memory utilization as a portion of memory capacity.

12. The method of claim 1, wherein the server includes at least one connection through which clients may interface with the server and the characteristic is the number of connections that are open for client interface.

13. The method of claim 1, wherein the server includes at least one connection through which clients may interface with the server and the characteristic is the number of connections that are open for client interface as a portion of the number of connections present at the server.

14. A method of distributing data communication load between at least two servers, comprising:
including data describing an operating level of a characteristic that corresponds to server load as it relates to a first server in a message sent from the first server,
reading the operating level of the characteristic for the first server from the message sent from the first server at a load balancing agent,
including data describing an operating level of the characteristic that corresponds to server load as it relates to a second server in a message sent from the second server,
reading the operating level of the characteristic for the second server from the message sent from the second server at the load balancing agent,
transmitting a request from a client to the first server if the operating level of the characteristic of the first server and the operating level of the characteristic of the second server indicate that the first server is less loaded than the second server, and
transmitting the request from the client to the second server if the operating level of the characteristic of the first server and the operating level of the characteristic of the second server indicate that the second server is less loaded than the first server.

15. The method of claim 14, wherein the message sent from the first server and the message sent from the second server are messages sent to at least one client.

16. The method of claim 14, wherein the operating level of the characteristic is included in a header of a communication protocol utilized to transmit the message from the server to the load balancer.

17. A server, comprising:
a processor containing instructions which, when executed by the processor, cause the processor to write an operating level of a characteristic of the server in a message responding to a request from a client, the message being received by a load balancer and the client.

18. The server of claim 17, wherein the operating level of the characteristic is written in a header of a communication protocol utilized to transmit the message to the load balancer and the client.

19. The server of claim 17, further comprising a communication adaptor coupled to the processor and communicating with the client, and the load balancer.

20. A load balancer, comprising:
a processor containing instructions which, when executed by the processor, cause the processor to:
read an operating level of a characteristic related to a first server corresponding to the portion of the first server being utilized;
read an operating level of the characteristic related to a second server corresponding to the portion of the second server being utilized;
transmit a request from a client to the first server if the portion of the first server being utilized is less than the portion of the second server being utilized; and
transmit the request from the client to the second server if the portion of the second server being utilized is less than the portion of the first server being utilized.

21. The load balancer of claim 20, further comprising a communication adaptor coupled to the processor and communicating with the client, the first server, and the second server.

22. The load balancer of claim 20, wherein the operating level of the characteristic of the first server is read from a message transmitted by the first server and the operating level of the characteristic of the second server is read from a message transmitted by the second server.

23. The load balancer of claim 22, wherein the message transmitted by the first server is transmitted to a second client and the message transmitted by the second server is transmitted to a third client.

24. The load balancer of claim 23, wherein:
the message transmitted by the first server includes a first header and the operating level of the characteristic of the first server is read from the first header; and
the message transmitted by the second server includes a second header and the operating level of the characteristic of the second server is read from the second header.

25. A load balancing system, comprising:
a first client coupled to a network and communicating a request over the network;
a first server coupled to the network and communicating a current operating level of a characteristic of the first server that corresponds to the load of the first server in a message transmitted to a second client over the network;
a second server coupled to the network and communicating a current operating level of the characteristic of the second server that corresponds to the load of the second server in a message transmitted to a third client over the network; and
a load balancer coupled to the network and having a processor, the processor having instructions that, when executed by the processor, cause the processor to:
receive the request from the first client;
receive the message transmitted from the first server to the second client and read therefrom the current operating level of the characteristic of the first server;
receive the message transmitted from the second server to the third client and read therefrom the current operating level of the characteristic of the second server;
transmit the request from the first client to the first server if the load of the first server is less than the load of the second server; and
transmit the request from the first client to the second server if the load of the second server is less than the load of the first server.

26. The system of claim 25, wherein the current operating level of the characteristic of the first server and the current operating level of the characteristic of the second server are included in headers of a communication protocol utilized to transmit the messages over the network.

27. An article of manufacture comprising:
a computer readable medium having stored thereon instructions which, when executed by a processor, cause the processor to:
read an operating level of a characteristic of a first server, the operating level of the characteristic of the first server corresponding to the portion of the first server being utilized;
read an operating level of a characteristic of a second server, the operating level of the characteristic of the second server corresponding to the portion of the second server being utilized;
transmit a request from a client to the first server if the portion of the first server being utilized is less than the portion of the second server being utilized; and
transmit the request from the client to the second server if the portion of the second server being utilized is less than the portion of the first server being utilized.

28. The article of manufacture of claim 27, wherein:
the operating level of the characteristic of the first server is read from a message transmitted from the first server to a second client; and
the operating level of the characteristic of the second server is read from a message transmitted from the second server to a third client.

29. The article of manufacture of claim 28, wherein the operating levels of the characteristic of the first server and the operating level of the characteristic of the second server are read from headers of a communication protocol utilized to transmit the messages over a network.
